(19) United States
(12) Patent Application Publication
(10) Pub. No.: US 2015/0301653 A1
(43) Pub. Date: Oct. 22, 2015

(54) SEMICONDUCTOR DEVICE, DISPLAY SYSTEM, DETECTION METHOD, AND NON-TRANSITORY COMPUTER READABLE MEDIUM

(71) Applicant: LAPIS Semiconductor Co., Ltd., Kanagawa (JP)

(72) Inventor: Takahiro URUSHI, Kanagawa (JP)

(73) Assignee: LAPIS Semiconductor Co., Ltd., Kanagawa (JP)

(21) Appl. No.: 14/685,582

(22) Filed: Apr. 13, 2015

(30) Foreign Application Priority Data
Apr. 18, 2014 (JP) 2014-086531

(51) Int. Cl. G06F 3/044; G06F 3/041

(52) U.S. Cl. CPC G06F 3/044; G06F 3/0418; G06F 3/0412

(57) ABSTRACT

The present invention provides a semiconductor device including: a detection section that acquires an output signal, which has an amplitude and is output from an analog-to-digital converter that converts a detection signal output from a capacitance type touch panel into a digital signal, that compares the output signal with a reference signal, and that, in a case in which a variation amount of the output signal with respect to the reference signal exceeds a first threshold value, detects whether a touching state of the touch panel is touched or not based on a time variation of the output signal.

### CROSS-REFERENCE TO RELATED APPLICATION

This application claims priority under 35 USC 119 from Japanese Patent Application No. 2014-086531 filed Apr. 18, 2014, the disclosure of which is incorporated by reference herein.

### BACKGROUND OF THE INVENTION

1. Field of the Invention

The present invention relates to a semiconductor device, a display system, a detection method, and a non-transitory computer readable medium storing a detection program.

2. Description of the Related Art

Generally, capacitance type touch panels are employed as touch panels. In such touch panels, detection of a touching state of a user with respect to the touch panel is performed.

It is known that malfunction occurs due to the influence of disturbance noise, such as fluorescent lights or other electromagnetic waves. To reduce such disturbance noise, for example, Japanese Patent Application Laid-Open (JP-A) No. 2011-8724, discloses such a technology. Further, it is also known that malfunction occurs when drops of water falls on the touch panel surface. To reduce such malfunction, for example, JP-A No. 2008-112334, discloses such a technology.

However, in the technology described in JP-A No. 2011-8724, a drive signal is applied and controlled such that a detection signal is a polarity-alternating signal including a positive-negative asymmetric signal component caused by the presence of externally approaching object. Accordingly, reduction in disturbance noise cannot be achieved without employing a polarity-alternating signal.

Moreover, when the technology described in JP-A No. 2008-112334 is employed in a portable terminal, for example, drops of water move when the touch panel vibrates, and thus, malfunction occurs.

### SUMMARY OF THE INVENTION

The present invention provides a semiconductor device, a display system, a detection method, and a non-transitory computer readable medium storing a detection program that may accurately detect a touching state of a touch panel, even when a detection signal changes due to noise.

A first aspect of the present invention is a semiconductor device including: a detection section that acquires an output signal, which has an amplitude and is output from an analog-to-digital converter that converts a detection signal output from a capacitance type touch panel into a digital signal, that compares the output signal with a reference signal, and that, in a case in which a variation amount of the output signal with respect to the reference signal exceeds a first threshold value, detects whether a touching state of the touch panel is touched or not based on a time variation of the output signal.

A second aspect of the present invention is a display system including: a display section that displays an image based on an image signal; a capacitance type touch panel; an analog-to-digital converter that outputs an output signal which is a detection signal output from the touch panel and has been converted into a digital signal; and the semiconductor device of the first aspect that acquires the output signal, and that detects a touching state of the touch panel.

A third aspect of the present invention is a detection method including: acquiring, by a detection section, an output signal that has an amplitude and is output from an analog-to-digital converter that converts a detection signal output from a capacitance type touch panel into a digital signal; and comparing, by the detection section, the output signal with a reference signal and, in a case in which a variation amount of the output signal with respect to the reference signal exceeds a first threshold value, detecting whether a touching state of the touch panel is touched or not, based on a time variation of the output signal.

A fourth aspect of the present invention is a non-transitory computer readable medium storing a detection program that causes a computer to execute a process, the process including: acquiring an output signal that has an amplitude and is output from an analog-to-digital converter that converts a detection signal output from a capacitance type touch panel into a digital signal; and comparing the output signal with a reference signal and, in a case in which a variation amount of the output signal with respect to the reference signal exceeds a first threshold value, detecting whether a touching state of the touch panel is touched or not, based on a time variation of the output signal.

According to the above aspects, the present invention may accurately detect a touching state of a touch panel, even when a detection signal changes due to noise.

### BRIEF DESCRIPTION OF THE DRAWINGS

Exemplary embodiment of the present invention will be described in detail based on the following figures, wherein:

FIG. 1 is a schematic configuration diagram illustrating a display system of an exemplary embodiment;

FIG. 2 is a specific example of a waveform diagram for explaining a change from touched state to not touched state in an output signal output from an A/D converter;

FIG. 3 is a specific example of a waveform diagram of an output signal output from an A/D convertor in a case in which a capacitance type touch panel is brought close to a fluorescent light, positioned 5 cm away, and the fluorescent light switch is switched to ON state;

FIG. 4 is a specific example of a waveform diagram of moving average values for a moving average achieved from the waveform illustrated in FIG. 3;

FIG. 5 is a specific example of a waveform diagram of an output signal, in a case in which a touching state of the touch panel is not touched;

FIG. 6 is a specific example of a waveform diagram of an output signal in a case in which a touching state of the touch panel is touched;

FIG. 7 is a flowchart illustrating a detection process executed by a detection section of the present exemplary embodiment;

FIG. 8 is a specific example of a waveform diagram of an output signal for explaining a change in a touching state of the touch panel; and

FIG. 9 is a specific example of a waveform diagram of an output signal in a case in which a touching state of the touch panel of the present exemplary embodiment is not touched, and disturbance noise occurs.

### DETAILED DESCRIPTION OF THE INVENTION

Herebelow, an exemplary embodiment will be described in detail with reference to the drawings.

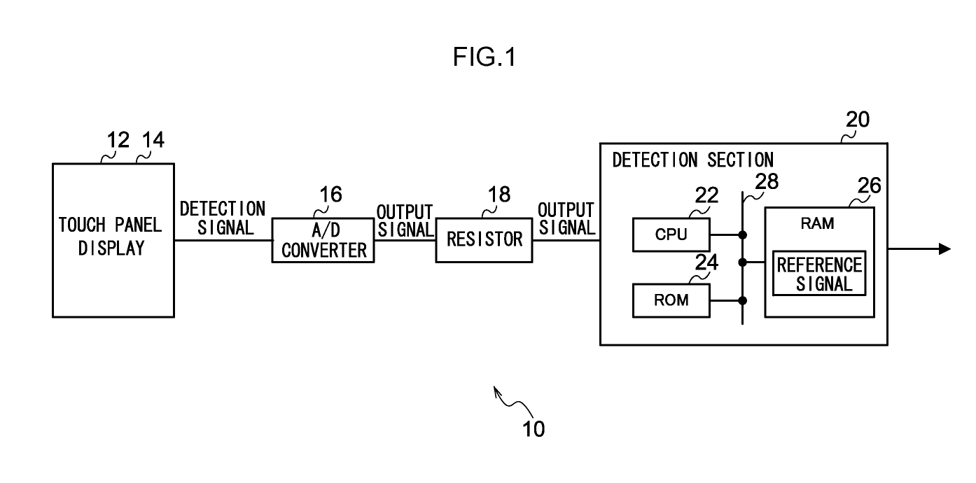

Explanation first follows regarding a configuration of a display system of the present exemplary embodiment. FIG. 1 is a schematic configuration diagram of the display system of the present exemplary embodiment.

As illustrated in FIG. 1, a display system 10 of the present exemplary embodiment includes a touch panel 12, a display 14, an analog-to-digital (A/D) converter 16, a resistor 18, and a detection section 20. Specific examples of the display system 10 are portable devices such as a smartphone or a tablet terminal, a display of a computer, and other display devices.

The touch panel 12 is what is referred to as a projected type, out of the capacitance type touch panel. In the capacitance type touch panel 12, detection electrodes (not illustrated), such as an electrode pad provided on a detection circuit board, for detecting a touching state (touched or not touched) by a user, are disposed in a matrix.

The display 14, which is an example of a display section, is configured as an integral unit with the touch panel 12. A specific example of the display 14 is a liquid crystal display. Note that, the display 14 may be provided separately with respect to the touch panel 12.

The A/D converter 16 converts an analog detection signal output from the touch panel 12 into a digital signal, and outputs an output signal to the resistor 18. The detection signal corresponds to a voltage level detected by the detection electrodes of the touch panel 12.

The resistor 18 temporarily holds the output signal output from the A/D converter 16.

The detection section 20, which is an example of a semiconductor device, detects the touching state of the touch panel 12, based on the output signal acquired from the A/D converter 16 through the resistor 18. When the user touches the surface of the touch panel 12, capacitor with respect to ground is formed as a parasitic capacitance, with the detection electrodes and a finger of the user acting as electrodes. Since the electrostatic capacitance increases due to the formation of the parasitic capacitance, a drop in voltage occurs in the detection signal output from the detection electrodes. The detection section 20 detects the touching state of the touch panel 12 based on the amplitude of the output signal, as well as the drop in voltage.

Note that, the detection section 20 of the present exemplary embodiment includes a moving average filter for smoothing the acquired output signal, and detects the touching state based on moving average values of the output signal.

The detection section 20 includes a CPU 22, ROM 24, and RAM 26. The CPU 22, the ROM 24, and the RAM 26 are connected together through a bus 28. The CPU 22 controls the detection section 20, and detects the touching state by executing a detection program stored in the ROM 24. Further, the ROM 24 has a function of pre-storing the detection program. The RAM 26 of the present exemplary embodiment is, for example, non-volatile RAM (NVRAM) or the like. The RAM 26 has a function of storing a reference signal. The reference signal is a reference signal for detecting the touching state, and is a signal when the touch panel 12 is not touched. As a specific example, in the present exemplary embodiment, initial values of a signal, input from the A/D converter 16 through the resistor 18 when the touch panel 12 is never touched during manufacturing the touch panel 12, are sampled and are pre-stored in the RAM 26 as the reference signal. Threshold values TH1 to TH4, explained in detail below, are also pre-stored in the RAM 26.

Explanation follows regarding operation of the detection section 20 of the present exemplary embodiment.

In the capacitance type touch panel 12, a parasitic capacitance is formed when the user touches the surface of the touch panel 12, and a drop in the voltage of the detection signal occurs due to the increase of the electrostatic capacitance. Accordingly, a similar drop occurs in the output signal output from the A/D converter 16.

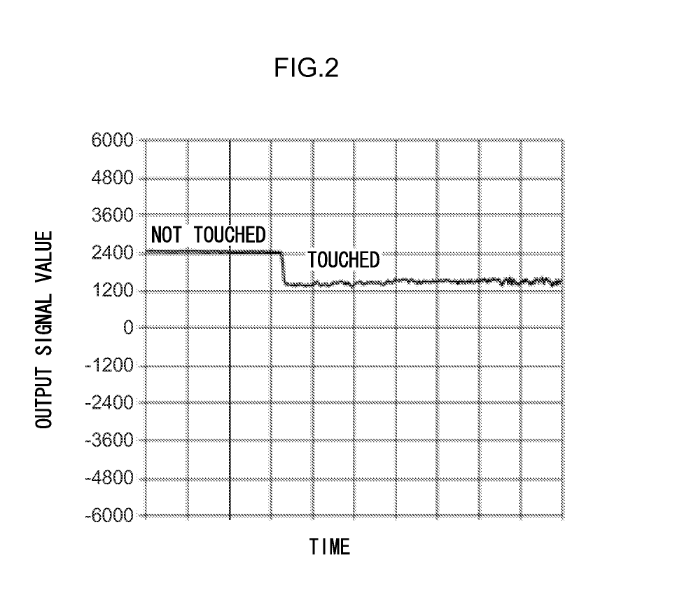

FIG. 2 illustrates a specific example of a waveform diagram for explaining a change from a not touched state to a touched state in an output signal output from the A/D converter 16. In the case illustrated in FIG. 2, the output signal value is a value close to 2400 when the touching state is not touched. Note that, although the output signal value has a corresponding relationship to the signal value of the detection signal (voltage value), the output signal value does not need to be the same value as the detection signal value.

When the touching state is touched, the output signal value drops by 1000 or more compared to the non-touching state. Thus, when the output signal value has dropped by 1000 or more, a change from the non-touching state to the touching state can be detected. In contrast, when the output signal value has risen by 1000 or more, a change from the touching state to the non-touching state can be detected.

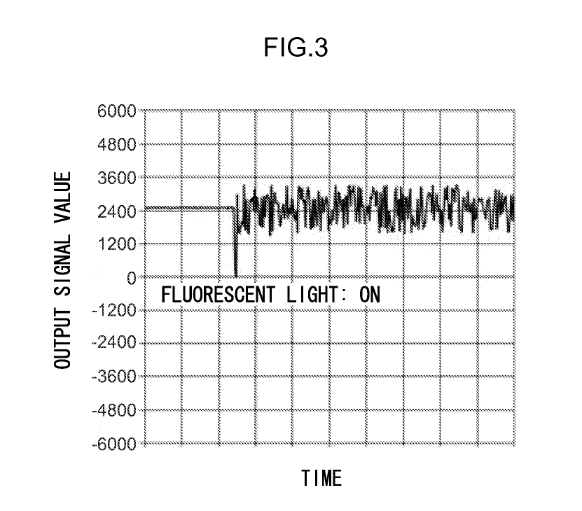

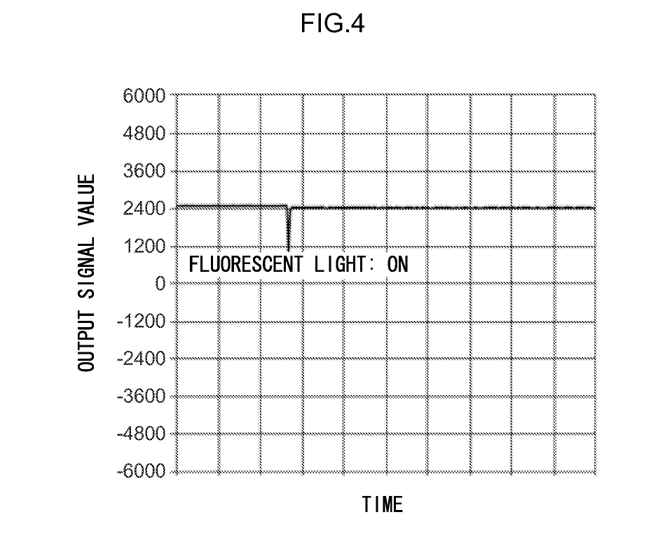

However, it is known that, in general, in capacitance type touch panels, the voltage changes and the signal value of the detection signal changes by switching a fluorescent light switch from an OFF state (unlit) to an ON state (lit). FIG. 3 illustrates a specific example of a waveform diagram of an output signal output from an A/D convertor in a case in which the touch panel 12 is brought close to a fluorescent light, positioned 5 cm away, and the fluorescent light switched to the ON state. FIG. 4 illustrates a specific example of a waveform diagram of moving average values of a moving average achieved from the waveform illustrated in FIG. 3.

As can be seen from FIG. 4, the waveform cannot be smoothed when the fluorescent light is switched to ON state, even when the moving average values are derived. Moreover, as illustrated in FIG. 4, the output signal value changes 1000 or more due to switching the fluorescent light to the ON state. Accordingly, the waveform when the fluorescent light is switched to ON state becomes a noise, and thus, the touching state of the touch panel 12 may be falsely detected.

In order to suppress such false detection due to noise, the inventors have discovered characteristics of the output signal when the touching state of the capacitance type touch panel (the touch panel 12) is touched.

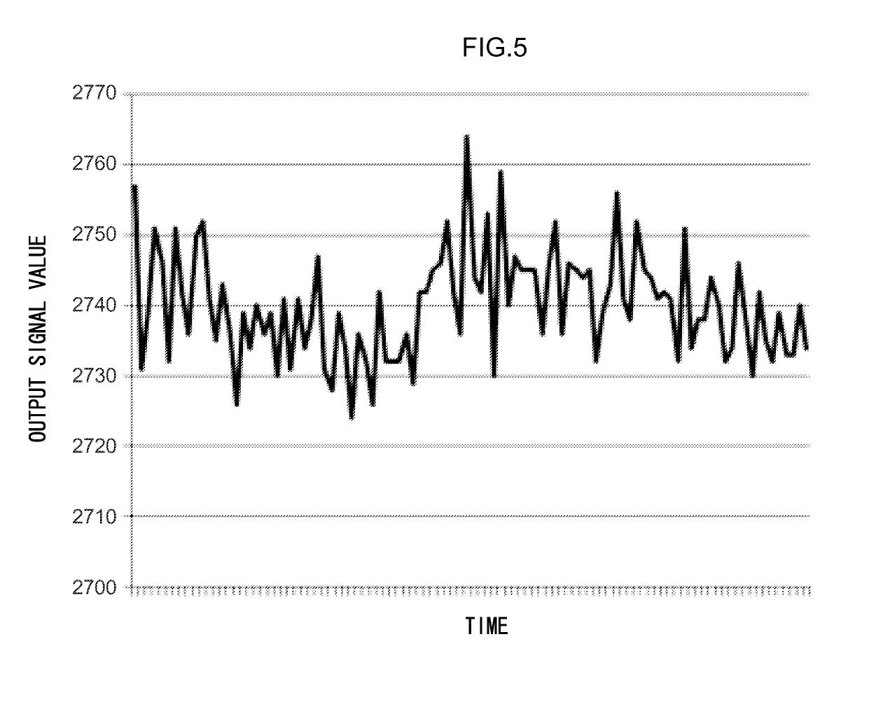

FIG. 5 illustrates a specific example of a waveform diagram of an output signal in a case in which the touching state of the touch panel 12 is not touched. Note that, the waveform illustrated in FIG. 5 is an output signal waveform, and not a moving average waveform. As illustrated in FIG. 5, the signal values of the output signal are substantially within a range of from 2730 to 2760, when the touching state is not touched. Thus, when the touch panel 12 is not touched, the output signal is a signal with an amplitude having a difference (amplitude swing) of approximately 30 between the maximum amplitude value and the minimum amplitude value.

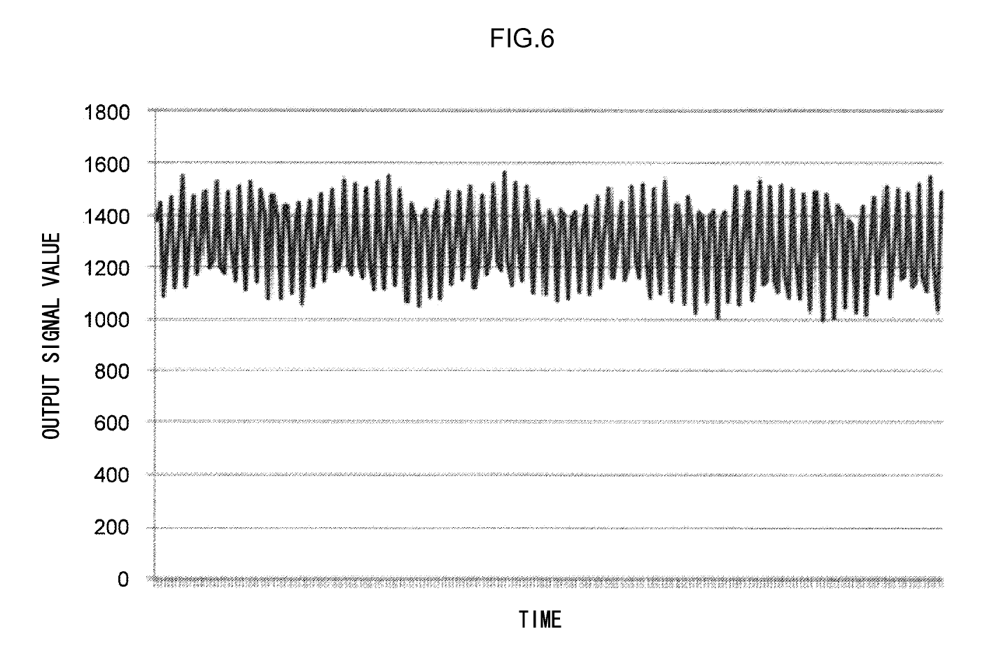

On the other hand, FIG. 6 illustrates a specific example of a waveform diagram of an output signal in a case in which the touching state of the touch panel 12 is touched. Note that, the waveform illustrated in FIG. 6 is also an output signal waveform, and not a moving average waveform. As illustrated in FIG. 6, the signal values of the output signal have an amplitude that equals to or more than 400, from 1000 to 1400 or more, when the touching state is touched. Further, the amplitude is cyclically repeated. Namely, when the touching state of the capacitance type touch panel (the touch panel 12) is touched, the output signal becomes a signal having a periodical waveform with a larger amplitude than in the non-touching state.

One contributing factor that causes the signal to have a periodical waveform with a larger amplitude when the touching state is touched, is the repeated rhythmical movement of the human body, which is referred to as tremors. It is thought that tremors occur even in humans in a healthy state. When the user touches the surface of the touch panel 12 (the detection electrodes) by a finger or the like, the grounded surface area of the finger with respect to the detection electrodes varies slightly due to the tremors. When the grounded surface area increases, the parasitic capacitance also increases, and when the grounded surface area decreases the parasitic capacitance also decreases. Thus, the amplitude of signal values (voltage values) of the detection signal increase, and the amplitude of the signal values of the output signal also increase as a result.

Thus in the detection section 20 of the present exemplary embodiment, when the touching state is touched, the touching state of the touch panel 12 is detected based on the output signal changing to a signal having a periodical waveform with a large amplitude. Namely, the detection section 20 detects the touching state of the touch panel 12 based on the change in the signal values, and the swing in the amplitude of the signal values, of the output signal.

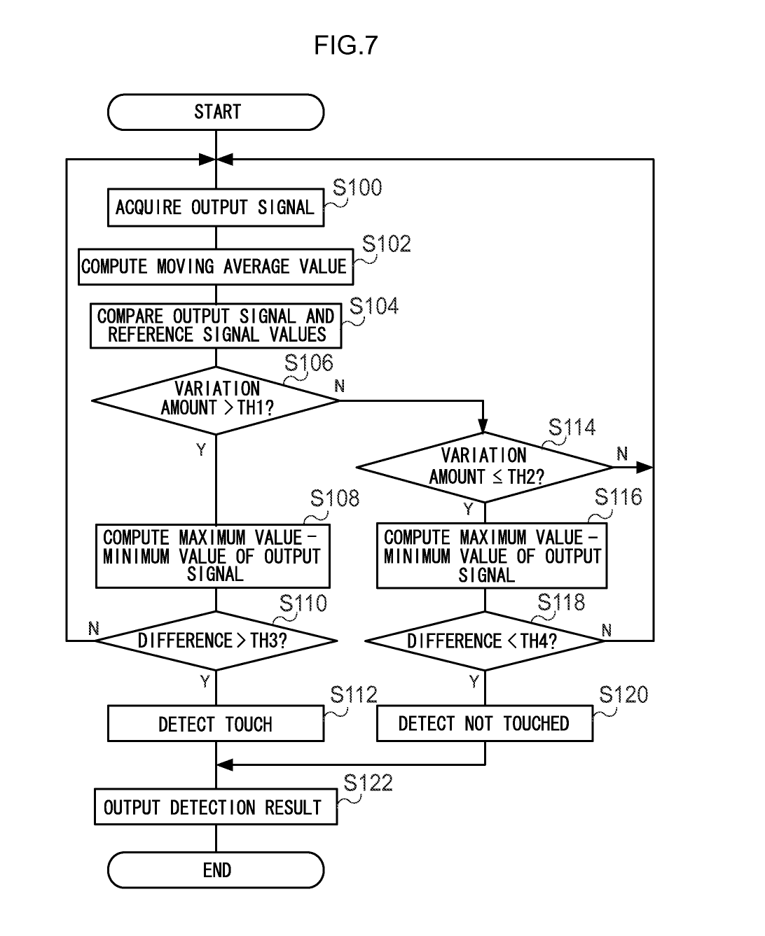

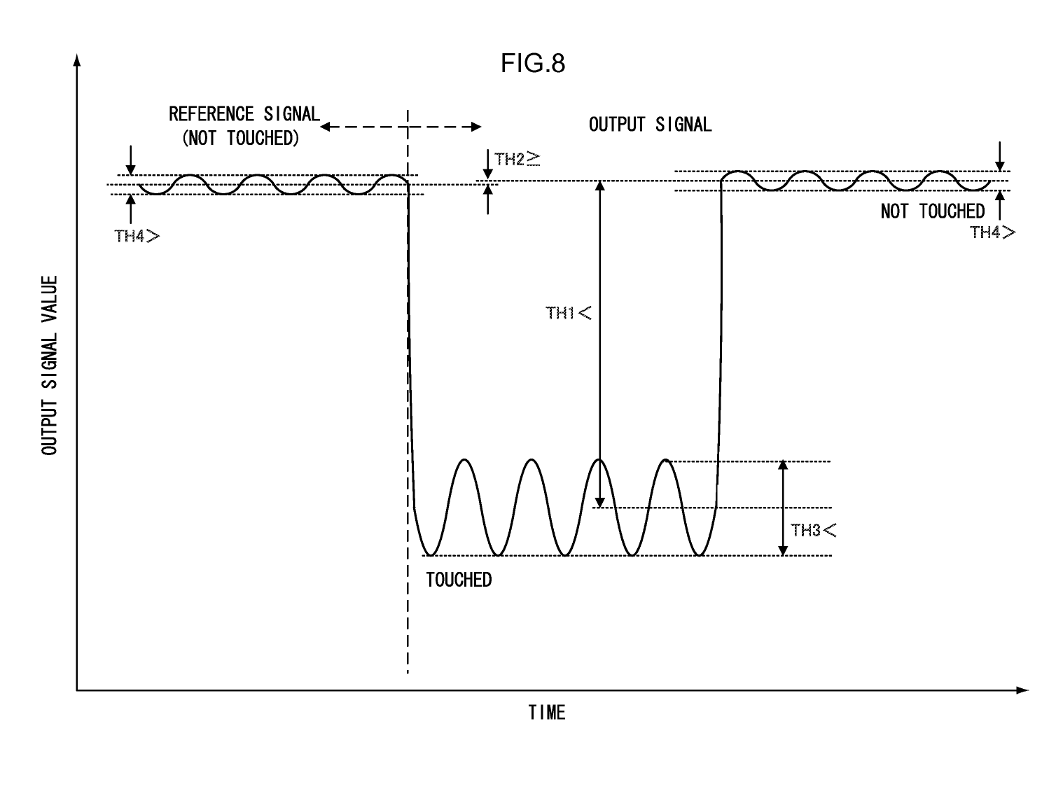

FIG. 7 is a flowchart illustrating a detection process executed by the detection section 20 of the present exemplary embodiment. FIG. 8 illustrates a specific example of a waveform diagram of an output signal for explaining a change in the touching state. Note that FIG. 8 is a waveform diagram of moving average values of a moving average derived for the output signal. In FIG. 8, for ease of explanation, the reference signal and the output signal are illustrated continuously.

Note that, the detection process illustrated in FIG. 7 is executed, for example, when the display system 10 is activated.

It step S100, the detection section 20 acquires an output signal from the A/D converter 16 through the resistor 18. Note that, the detection section 20 of the present exemplary embodiment acquires (samples) the output signal with certain intervals.

Next, in step S102, the detection section 20 computes a moving average value of the output signal. The detection section 20 derives the moving average value by, for example, applying a moving average filter to the acquired output signal.

Next, in step S104, the detection section 20 compares the output signal that is the moving average value with the reference signal, and in next step S106 the detection section 20 determines whether or not the variation amount exceeds the threshold value TH1.

In the present exemplary embodiment, as stable values of the reference signal and the output signal, intermediate values of the amplitude of each signal (intermediate value between the maximum value and the minimum value, hereafter referred to as “intermediate value”) are used as a reference. As illustrated in FIG. 8, the detection section 20 determines whether or not the variation amount of the intermediate values exceeds the threshold value TH1. The threshold value TH1 is predetermined as a threshold value for detecting a change in touching state from touched to not touched. Note that, for example, 1000 is applied in the above specific example.

When the variation amount>threshold value TH1, there is a possibility that there has been a change from the touching state to the non-touching state, and so process proceeds to step S108.

In step S108, the detection section 20 computes the difference between the maximum value and the minimum value (maximum value−minimum value) of the amplitude as the time variation of the output signal. The detection section 20 detects the maximum value and the minimum value of the amplitude by updating the maximum value when the acquired output signal value is higher than the maximum value that has been previously acquired, and by updating the minimum value when the acquired output signal value is lower than the minimum value that has been previously acquired. The detection section 20 of the present exemplary embodiment derives average values of the maximum values and minimum values respectively, and uses the derived average values.

In next step S110, the detection section 20 determines whether or not the difference between the maximum value and the minimum value exceeds the threshold value TH3. The threshold value TH3 is predetermined based on the amplitude of the output signal waveform when in the touching state. Note that, for example, 400 is applied in the above specific example.

In a case in which the difference>threshold value TH3 is negative, namely, in a case in which the difference≦threshold value TH3, since the touching state has not changed, the process returns to step S100, and the process is repeated.

On the other hand, the process proceeds to step 112 in a case in which the difference>threshold value TH3. In step S112, touch in the touch panel 12 is detected, specifically, a change in the touching state from not touched to touched is detected, and the process proceeds to step S122.

In a case in which the variation amount>the threshold value TH1 is negative in step S106, namely, in a case in which the variation amount≦the threshold value TH1, the process proceeds to step S114.

In step S114, determination is made whether or not the variation amount is the threshold value TH2 or lower. As illustrated in FIG. 8, the detection section 20 determines whether or not the variation amount between the intermediate values is equal to or lower than the threshold value TH2. The threshold value TH2 is a threshold value for detecting the not touched state. Since the reference signal is a signal when the touching state is not touched, the difference between the reference signal and the output signal in the non-touching state is small. In the present exemplary embodiment, the threshold value TH2 is acquired in advance by testing or the like, similarly to the specific example above. As illustrated in FIG. 8, the threshold value TH2 is smaller than the threshold value TH1.

In a case in which the variation amount≦the threshold value TH2 is negative, namely in a case in which the variation amount>the threshold value TH2, the non-touching state is not present, and a touching state is continuing. Accordingly, the process returns to step S100 and the process is repeated.

On the other hand, in a case in which the variation amount≦the threshold value TH2, process proceeds to step S116. In step S116, similarly to step S108 above, the detection section 20 computes the difference between the maximum value and the minimum value (maximum value−minimum value) of amplitude as the time variation of the output signal.

In next step 118, the detection section 20 determines whether or not the difference between the maximum value and the minimum value is lower than the threshold value TH4. The threshold value TH4 is predetermined based on the amplitude of the output signal waveform when in the non-touching state. Note that, for example, 30 is applied in the above specific example. As described above, the threshold value TH4 is smaller than the threshold value TH3.

In a case in which the difference<the threshold value TH4 is negative, namely, in a case in which the difference≧the threshold value TH4, the non-touching state is not present. Accordingly, the process returns to step S100 and the process is repeated.

On the other hand, in a case in which the difference<the threshold value TH4, the process proceeds to step S120. In step S120, not touched of the touch panel 12 is detected, and the process proceeds to step S122.

In step S122, a detection result indicating whether the touching state is touched or not touched is output to a later stage functional section of the detection section 20 of the display system 10, and the process ends.

As explained above, in the display system 10 of the exemplary embodiment above, an analog output signal output from the touch panel 12 is converted into a digital output signal and is output as an output signal from the A/D converter 16. The detection section 20 acquires the output signal output from the A/D converter 16 through the resistor 18. A reference signal, based on a detection signal output from the touch panel 12 in the non-touching state, is stored in advance in the detection section 20. The detection section 20 compares the reference signal with the output signal, and computes the variation amount. In a case in which the variation amount is more than the threshold value TH1, determination is made whether or not the difference between the maximum value and the minimum value of the output signal amplitude exceeds the threshold value TH3. In a case in which the threshold value TH3 is exceeded, the touched state of the touch panel 12 is detected. In a case in which the variation amount is the threshold value TH2 or lower, the detection section 20 determines whether or not the difference between the maximum value and the minimum value of the output signal amplitude is lower than the threshold value TH4. In a case in which this is lower than the threshold value TH4, the not touched state of the touch panel 12 is detected.

Namely, in a case in which the variation amount of the output signal from the reference signal is large and the swing in amplitude of the output signal is also large, the detection section 20 of the display system 10 of the present exemplary embodiment detects that the touching state of the touch panel 12 is touched. Moreover, in a case in which the variation amount of the output signal with respect to the reference signal is small and the swing in amplitude of the output signal is also small, the detection section 20 of the display system 10 of the present exemplary embodiment detects that the touching state of the touch panel 12 is not touched.

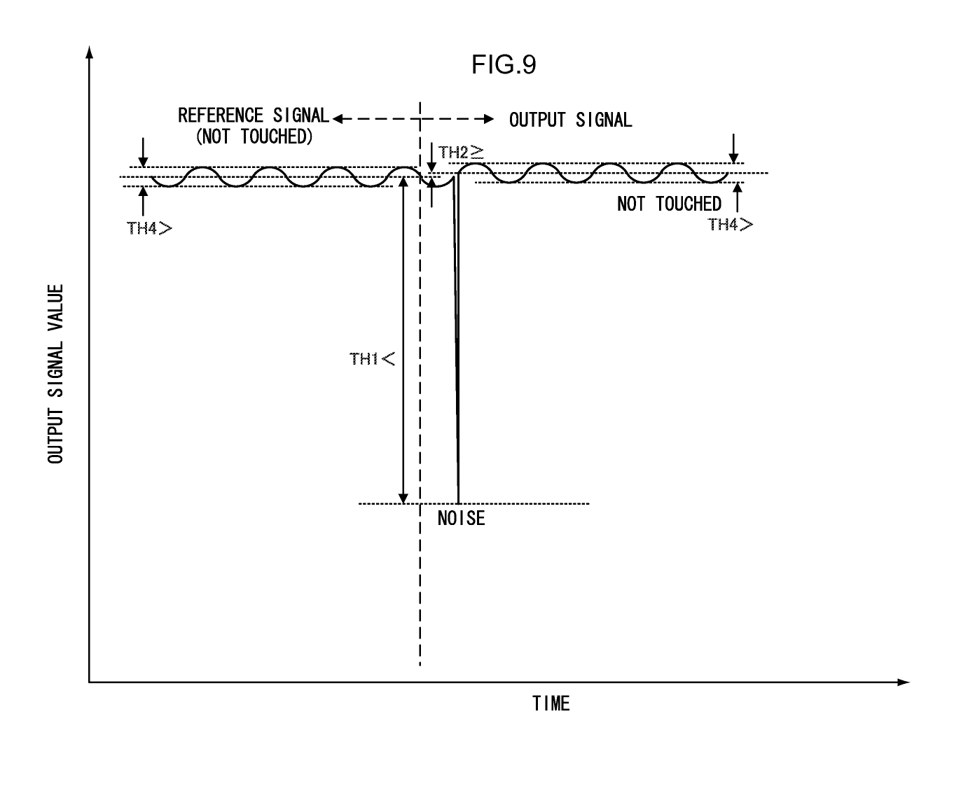

FIG. 9 illustrates a specific example of a waveform diagram of an output signal in a case in which the touching state of the touch panel 12 is not touched, and disturbance noise as described above occurs. Note that, similarly to FIG. 8, FIG. 9 is a waveform diagram of moving average values of a moving average derived for the output signal. Also similarly to FIG. 8, the reference signal and the output signal are illustrated continuously for ease of explanation.

As illustrated in FIG. 9, the variation amount of the output signal with respect to the reference signal may exceed the threshold TH1 when disturbance noise occurs. However, the swing in the output signal amplitude is lower than the threshold value TH4, and does not exceed the threshold value TH3. Thus, the detection section 20 does not detect the touching state of the touch panel 12 as touched. Accordingly, in the detection section 20 of the present exemplary embodiment, false detection of the touching state may be suppressed.

Thus, in the detection section 20 of the display system 10 of the present exemplary embodiment, the touching state of the touch panel 12 is detected based on the variation amount of the output signal with respect to the reference signal and the swing in the amplitude. This enables the touching state of the touch panel 12 to be accurately detected, even in a case in which the detection signal changes due to noise.

Note that, although the reference signal is pre-stored in the RAM 26 in the detection section 20 of the present exemplary embodiment, configuration is not limited thereto. For example, the intermediate values of the reference signal may be pre-stored instead of a signal having a waveform.

Moreover, in the detection section 20 of the present exemplary embodiment, the variation amount was computed by comparing the intermediate values of the reference signal and the output signal. However, the configuration is not limited thereto. For example, respective maximum values, or respective minimum values, may be compared with each other.

Moreover, although the touching state of the touch panel 12 is detected based on the difference between the maximum value and the minimum value of the amplitude as the time variation of the output signal in the present exemplary embodiment, the time variation is not limited thereto. For example, the cyclic pattern (interval) of the maximum value or the minimum value, or the like, may also be employed as the time variation.

In the present exemplary embodiment, in order to smooth the output signal output from the A/D converter 16, the moving average is derived using a moving average filter. However, the output signal may be smoothed by any another method.

Note that, configurations and operations of the display system 10, the touch panel 12, the display 14, the detection section 20, and so on described in the above exemplary embodiment are merely examples, and obviously, changes and modifications are possible according to circumstances within a range not departing from the spirit of the present invention.

What is claimed is:

1. A semiconductor device comprising:
a detection section that acquires an output signal, which has an amplitude and is output from an analog-to-digital converter that converts a detection signal output from a capacitance type touch panel into a digital signal, that compares the output signal with a reference signal, and that, in a case in which a variation amount of the output signal with respect to the reference signal exceeds a first threshold value, detects whether a touching state of the touch panel is touched or not based on a time variation of the output signal.

2. The semiconductor device of claim 1, wherein, in a case in which the variation amount of the output signal with respect to the reference signal is equal to or less than a second threshold value, which is lower than the first threshold value, the detection section detects the touching state of the touch panel is touched, based on the time variation of the output signal.

3. The semiconductor device of claim 1, wherein the time variation is a difference between a maximum value and a minimum value of the amplitude of the output signal, and
wherein, in a case in which the difference exceeds a third threshold value, the detection section detects whether the touching state of the touch panel is not touched or not.

4. The semiconductor device of claim 1, wherein the time variation is a difference between a maximum value and a minimum value of the amplitude of the output signal, and
wherein, in a case in which the difference is lower than a fourth threshold value, the detection section detects that the touching state of the touch panel is not touched.

5. The semiconductor device of claim 3, wherein the time variation is the difference between the maximum value and the minimum value of the amplitude of the output signal; and
wherein, in a case in which the difference is lower than a fourth threshold value, which is lower than the third threshold value, the detection section detects the touching state of the touch panel as not touched.

6. The semiconductor device of claim 1, wherein the detection section compares a moving average of the output signal acquired from the analog-to-digital converter with the reference signal.

7. The semiconductor device of claim 1, wherein the reference signal is a signal that is acquired in advance when the touch panel is in a non-touching state.

8. A display system comprising:
a display section that displays an image based on an image signal;
a capacitance type touch panel;
an analog-to-digital converter that outputs an output signal which is a detection signal output from the touch panel and has been converted into a digital signal; and
the semiconductor device of claim 1 that acquires the output signal, and that detects a touching state of the touch panel.

9. A detection method comprising:
acquiring, by a detection section, an output signal that has an amplitude and is output from an analog-to-digital converter that converts a detection signal output from a capacitance type touch panel into a digital signal; and
comparing, by the detection section, the output signal with a reference signal and, in a case in which a variation amount of the output signal with respect to the reference signal exceeds a first threshold value, detecting whether a touching state of the touch panel is touched or not, based on a time variation of the output signal.

10. A non-transitory computer readable medium storing a detection program that causes a computer to execute a process, the process comprising:
acquiring an output signal that has an amplitude and is output from an analog-to-digital converter that converts a detection signal output from a capacitance type touch panel into a digital signal; and
comparing the output signal with a reference signal and, in a case in which a variation amount of the output signal with respect to the reference signal exceeds a first threshold value, detecting whether a touching state of the touch panel is touched or not, based on a time variation of the output signal.
